(19) United States
(12) Patent Application Publication
(10) Pub. No.: US 2024/0278225 A1
(43) Pub. Date: Aug. 22, 2024

(54) METHOD FOR ACTIVATING A CATALYST

(71) Applicants: LINDE GMBH, Pullach (DE); BASF SE, Ludwigshafen am Rhein (DE)

(72) Inventors: Nicole SCHÖDEL, Pullach (DE); Stephanie NEUENDORF, Pullach (DE); Axel BEHRENS, Pullach (DE); Wibke KORN, Pullach (DE); Sonja SCHULTE, Pullach (DE); Stefan HOFFMANN, Pullach (DE); Marcelo Daniel KAUFMAN RECHULSKI, Ludwigshafen (DE); Virginie LANVER, Ludwigshafen (DE); Stefan DIETRICH, Heidelberg (DE); Nils BOTTKE, Heidelberg (DE); Christiane KURETSCHKA, Ludwigshafen (DE); Hamideh AHI, Ludwigshafen am Rhein (DE); Manuel Frederik GENTZEN, Ludwigshafen am Rhein (DE); Michael KRAMER, Ludwigshafen am Rhein (DE)

(21) Appl. No.: 18/568,559

(22) PCT Filed: May 11, 2022
(86) PCT No.: PCT/EP2022/025217

§ 371 Date: Dec. 8, 2023

(30) Foreign Application Priority Data
Jun. 15, 2021 (EP) 21020314.7

(51) Int. Cl. B01J 37/10; B01J 21/04; B01J 23/78; B01J 23/83; B01J 37/18; C01B 3/40

(52) U.S. Cl. CPC B01J 37/10; B01J 21/04; B01J 23/78; B01J 23/83; B01J 37/18; C01B 3/40; C01B 2203/0238; C01B 2203/1052; C01B 2203/1082

(57) ABSTRACT

The invention relates to a method for activating a catalyst for catalytic reforming that is particularly carried out with carbon dioxide being reacted, and according to which an activation gas that contains steam and hydrogen is passed over the catalyst to be activated at an activation temperature during an activation period. The activation gas comprises 10 to 30 mol-% steam, 40 to 60 mol-% hydrogen and 20 to 40 mol-% one or more inert gases.

The present invention relates to a method for activating a catalyst for catalytic reforming that is particularly carried out with carbon dioxide being reacted and at low molar ratios of steam to organic carbon, and to a corresponding method for producing synthesis gas.

### BACKGROUND

Various methods are used for the production of synthesis gas, a mixture comprising hydrogen and carbon monoxide in variable proportions and optionally carbon dioxide, for example co-electrolysis of carbon dioxide and water or steam reforming of crude oil, natural gas, coal or biomass, or gases produced therefrom. Dry reforming of carbon dioxide is also known and is additionally referred to as carbon dioxide reforming. This can be used alongside other methods within the scope of the present invention.

In principle, the following reactions can take place in simplified form:

H₂O+CH₄→3H₂+CO (steam reforming) (1)

CH₄+CO₂→2H₂+2 CO (dry reforming) (2)

In addition to methane, other hydrocarbons or organic feedstocks can also be used for these methods. However, the basic chemistry typically does not change, so that the reaction equations presented can apply as model reactions for reactions of larger molecules. The term “organic feedstock” therefore applies here to one or more of the compounds methane, ethane, propane, butane, optionally higher hydrocarbons having more than four carbon atoms, as well as unsaturated derivatives thereof and alcohols of the same chain length, but also, for example, aromatics. In particular, an organic feedstock, as can be used within the scope of the present invention, may comprise hydrocarbons such as those contained, for example, in natural gas, heavy natural gas, liquefied petroleum gas (LPG) or naphtha, or oxygenates such as alcohols. A feed mixture comprising corresponding organic feedstocks may also contain, for example, carbon dioxide or other components, as is particularly the case with biogas.

In principle, a combination of the reforming modes of steam and dry reforming is also known, so that variable quantities of steam, carbon dioxide and organic feedstock may be used. As a result, the composition of the product mixture formed and thus of the synthesis gas produced can be controlled at least within certain limits.

It is also possible, for example, to use catalysts which, according to the reaction equation given above for dry reforming, (also) catalyze a reaction of hydrocarbons, in particular methane, and carbon dioxide to form hydrogen and carbon monoxide, but to use these in the presence of a certain quantity of steam. Typically, these are usually precious metal-based catalysts that are used at low pressure. Steam and dry reforming are summarized here by the term “catalytic reforming”, wherein the present invention relates in particular to methods in which at least the reaction specified for dry reforming also takes place and which are therefore referred to as “catalytic reforming with carbon dioxide being reacted”. However, the invention can also be carried out without carbon dioxide being reacted.

Conventional steam reforming generally uses catalysts that are inactive in an oxidized state but active for the reforming reaction in a reduced state. Since these catalysts usually oxidize in air or are stable in air in the oxidized state, they must be activated in order to achieve full performance. For this purpose, a gas mixture having reducing properties is conventionally passed over the catalyst bed of the reactor used under the appropriate process conditions.

Conventionally, a mixture of steam with natural gas or naphtha with an S/C ratio of more than 5:1 is used to activate the catalyst. The S/C ratio, hereinafter also referred to as the “molar ratio of steam to organic carbon”, is always understood below to mean the quotient of the quantity of steam (in mol) and the quantity of carbon (in mol), wherein the latter takes into account the organic feedstock(s), but not carbon dioxide. In this way, the formation of carbon build-up is reduced and the formation of hydrogen is favored over the formation of carbon monoxide. As soon as the steam reforming reaction begins, the catalyst is fully activated by the hydrogen formed. After activation, the quantity of steam is reduced to the value intended for regular operation.

Another known method for activating corresponding catalysts consists in feeding steam and hydrogen in a ratio of more than 6:1 without the use of hydrocarbons.

More rarely, an already activated or reduced catalyst is also provided in the reaction tubes of the reformer. For this purpose, however, oxygen contact must be avoided during transport and filling, for example by providing a comparatively complex protective gas atmosphere. A corresponding method is typically not possible in practical use due to the increased effort involved.

Competitive reactions during steam reforming result in the above-mentioned formation of carbon build-up on the catalyst surface, which inactivates it. This carbon build-up can reduce the catalytic performance of the catalyst used. In order to prevent this, a quantity of steam is conventionally used that is sufficient to keep the carbon concentration correspondingly low in order to avoid carbon build-up. For this reason, a feed mixture having an S/C ratio of not less than 2 is typically used in conventional steam reforming processes. However, the quantity of steam required in order to prevent carbon build-up limits flexibility.

Catalysts have therefore been developed that may also be used at lower S/C ratios. For example, reference can be made in this context to WO 2013/118078 A1, in which a hexaaluminate-containing catalyst for reforming hydrocarbons is described. A complete reduction for this type of catalyst using high quantities of steam as is usually the case is not possible here, since a correspondingly formed atmosphere does not have sufficient reduction potential. Further details are also explained in more detail below with reference to examples.

There is therefore a need for advantageous solutions that also enable such catalysts to be reduced.

### DISCLOSURE OF THE INVENTION

This object is achieved by a method for activating a catalyst for catalytic reforming that is particularly carried out with carbon dioxide being reacted and at low molar ratios of steam to organic carbon according to the above definition, and a corresponding method for producing synthesis gas having the features of the corresponding independent claims. Advantageous embodiments of the invention result from the dependent claims as well as from the following description and the accompanying drawings.

As mentioned at the outset, catalysts which have recently become known, which can also be used at lower S/C ratios and optionally with certain proportions of carbon dioxide in the reaction feed for the methods under consideration here, have an extremely high efficiency in relation to the catalytic reforming process with an advantageous product range in certain cases (in particular a high ratio of carbon monoxide to hydrogen). Corresponding catalysts and their composition and preparation are explained in more detail below.

The method proposed according to the invention for activating a catalyst for catalytic reforming that is, as mentioned, particularly carried out with carbon dioxide being reacted, comprises passing an activation gas that contains steam and hydrogen over the catalyst to be activated at an activation temperature (see below) during an activation period. According to the invention, the activation gas comprises 10 to 30 mol-%, in particular 15 to 25 mol-% steam, 40 to 60 mol-%, in particular 45 to 55 mol-% hydrogen, and 20 to 40 mol-%, in particular 25 to 35 mol-% one or more inert gases, in particular selected from nitrogen and argon. For example, the hydrogen content during activation within the scope of the invention is 50 mol-% and the steam content is 20 mol-%.

The present invention therefore relates to catalytic reforming at low S/C ratios in the sense of the above definition, which is preferably, but not necessarily, carried out with carbon dioxide being reacted. The essence of the invention lies in the specific activation of the catalyst used. Solely for clarification, it should be noted that, according to the invention, activation is carried out in particular without the presence of carbon dioxide, but the subsequent regular production operation can also, as mentioned, be carried out with carbon dioxide being reacted.

The catalyst activated within the scope of the invention is in particular a hexaaluminate-containing catalyst comprising a hexaaluminate-containing phase which contains cobalt and at least one further element from the group of lanthanum, barium, and strontium. The cobalt content of the catalyst is, for example, in the range of 2 to 15 mol-%, preferably 3 to 10 mol-% and more preferably in the range of 4 to 8 mol-%; the content of the at least one further element from the group of lanthanum, barium, and strontium is in particular in the range of 2 to 25 mol-%, preferably 3 to 15 mol-%, more preferably 4 to 10 mol-%; and the aluminum content is in the range of 70 to 90 mol-%. In addition to the hexaaluminate-containing phase, the catalyst activated within the scope of the invention may contain 0 to 50 wt.-% oxidic secondary phase, wherein the proportion of oxidic secondary phase is preferably in the range of 3 to 40 wt.-% and more preferably in the range of 5 to 30 wt.-%. In addition, detailed descriptions of the catalyst to be activated within the scope of the invention can be found, among others, in WO2013/118078 and WO2020/157202.

Preparation of the catalyst may include, for example, contacting an aluminum source, preferably an aluminum hydroxide, with a cobalt-containing metal salt. In addition to the cobalt species, the metal salt has at least one element from the group of lanthanum, barium and strontium. This is followed in particular by drying and calcination, wherein the molded and dried material is preferably calcined at a temperature greater than or equal to 800° C. Following calcination, activation according to the invention is applied. Detailed descriptions can be found, among others, in WO2013/118078 and WO2020/157202.

The catalytic reforming applied according to the invention takes place in the form of a reaction of at least one organic feedstock according to the definition above and optionally carbon dioxide-containing feed gas to obtain a raw product gas containing at least carbon monoxide and hydrogen using a suitable catalyst by means of catalytic reforming. The catalyst used can in particular also be capable of reacting carbon dioxide, although, as mentioned, this is not a mandatory requirement. A low molecular weight organic compound may be part of or form part of the organic feedstock, in particular in the form of a hydrocarbon having one to three carbon atoms and in particular methane, and the at least one organic feedstock may also be provided in a gas mixture which optionally contains carbon dioxide.

The catalytic reforming, which within the scope of the invention is optionally carried out with carbon dioxide being reacted, is characterized in particular by the fact that the activated catalyst is used at a process temperature of greater than 700° C., preferably greater than 800° C., and more preferably greater than 900° C., wherein the process pressure is greater than 5 bar, preferably greater than 10 bar, and more preferably greater than 15 bar.

In order to avoid misunderstandings, it is emphasized that the present invention distinguishes between an activation of the catalyst, in which no production operation has yet taken place and the catalyst in particular has not yet been exposed to the organic feedstock, in particular not to any hydrocarbons, during an activation phase, and a regular operating mode, in which the activated catalyst is then used for the production of synthesis gas by means of catalytic reforming. The regular operating mode represents the regular and permanent operating mode. This operating mode is characterized by the production of the desired product range.

However, at the beginning of the regular operating phase, a start phase is advantageously provided, during which a successive change in the parameters of the feed gas is carried out in order to avoid transitions between activation and production operation that are too abrupt.

In certain embodiments, the reforming catalyst used in the present invention catalyzes a reaction according to reaction equation 2 indicated at the outset, i.e. of hydrocarbons, in particular methane, with carbon dioxide to form hydrogen and carbon monoxide. However, the reforming catalyst always (also) catalyzes a reaction according to reaction equation 1 indicated at the outset, i.e. of hydrocarbons, in particular methane, with water to form hydrogen and carbon monoxide. The reforming catalyst is characterized in that it is activated in the manner explained and proposed according to the invention.

In the regular operating phase, the feed gas, which is also the gas mixture with which the reforming catalyst is contacted, has an S/C ratio (i.e. a molar ratio of steam to organic carbon according to the above definition) of less than 2, in particular less than 1.5, more particularly less than 1.2. The S/C ratio can also in particular be more than 0.5.

To adjust the activation phase, it is advantageous to successively change the parameters of the feed gases in order to avoid transitions that are too abrupt. This is therefore the case in one embodiment of the invention.

Advantageously, the temperature during activation is at least 750° C., preferably above 800° C., particularly preferably above 850° C. and in particular up to 1000° C., preferably up to 950° C.

The hourly space velocity (i.e. the quotient of gas and catalyst volume per hour) during activation is in particular between 200 and 4000 h⁻¹, preferably between 400 and 3000 h⁻¹, particularly preferably between 700 and 3000 h⁻. Advantageously, the activation time is more than 4 hours, preferably more than 10 hours, and particularly preferably more than 16 hours.

As a result of the conditions proposed according to the invention during the activation phase, the reforming catalyst is activated gently and optimally over the entire catalyst bed without involving the risk that some parts of the plant are excessively stressed by an inhomogeneous temperature distribution during the subsequent regular operating phase. Consequently, by carrying out the activation phase of reforming according to the invention, damage to the plant and inefficient operation of the plant due to reduced load can be avoided, while at the same time optimal activation or reduction of the reforming catalyst is ensured.

In the regular operating phase, the feed gas parameters are successively adjusted so that the raw product gas is formed with a desired composition.

Advantageously, a molar ratio of steam to organic carbon in the feed mixture is adjusted in the range explained above.

Advantageously, a molar ratio of carbon dioxide to methane (if carbon dioxide is present in the feed mixture) of more than 0.5 is also adjusted in the feed mixture, preferably more than 1.0, particularly preferably more than 1.5, and in particular up to 2 or 3.

### DETAILED DESCRIPTION

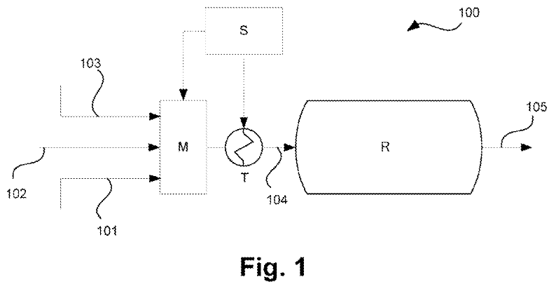

Further aspects and advantageous embodiments of the invention are explained in more detail below with reference to the attached drawing, wherein FIG. 1 shows an advantageous embodiment of a plant according to the invention schematically in the form of a block diagram.

The advantageous embodiment of a plant 100 shown in FIG. 1 comprises a reformer R, a control device S, as well as one or more mixers M1-x and a temperature control device T.

In the mixer, a plurality of raw gases 101, 102, 103 are mixed to form a feed gas 104. This mixing is controlled by the control device S, wherein the composition of the feed gas 104 from the raw gases 101, 102, 103 is specified by the control device S. In the example shown, the pressure and the flow speed of the feed gas 104 are also adjusted by the control device S via the mixer M. It should be emphasized that the feed gas 104 can also be provided via different mixers over a plurality of steps which, for example, comprise addition of carbon dioxide after a desulfurization unit, and no dedicated mixers may be required. The present invention is thereby not limited.

For this purpose, for example, valves on an inlet side of the mixer M are opened in accordance with the desired composition and a valve is adjusted on an outlet side of the mixer M in accordance with the desired pressure and/or the desired flow rate. It may also be provided that the mixer M additionally comprises pumps, compressors, throttles, turbines or similar means suitable for influencing pressure and/or flow rate of the feed gas 104. Through suitable selection and control of the mixer components, the flow rate of the feed gas 104 may be adjusted independently of its pressure.

It is understood that the mixer M is configured such that it can convert all raw gases 101, 102, 103 required for processing into the feed gas 104. For this purpose, it can in particular be provided that more than three raw gases are mixed with one another. For the sake of clarity, however, only three raw gases 101, 102, 103 are shown in FIG. 1.

The temperature control device T brings the feed gas 104, which is provided by the mixer M, to the temperature specified by the control device. In order to achieve this, in certain embodiments sensors can be provided which send data about the temperature of the feed gas 104, for example at the output of the temperature control device T, to the control device S. Depending on whether the temperature of the feed gas 104 deviates upward or downward from the desired temperature, this can then send a corresponding signal to the temperature control device T in order to cause the temperature control device to adjust the temperature of the feed gas 104 to the desired temperature. Multistage mixing or temperature control may also be provided.

The temperature control device T is equipped, for example, with heating elements, cooling elements, and/or heat exchangers, which are in thermal contact with the feed gas 104 and supply or extract heat from the feed gas 104 by corresponding control, which is initiated by the control device S.

In some embodiments, which are not necessarily part of the invention, it may also be provided that the temperature control device T is provided as a distributed device that allows the temperature to be influenced at various points in the plant 100. For example, as shown in FIG. 1, it may be provided that the feed gas 104 is brought to an operating temperature by a first part of the temperature control device T before it enters the reformer R, while the temperature is adjusted in the middle of the reformer by a second part of the temperature control device T (not shown in FIG. 1). Temperature control of one or more of the raw gases 101, 102, 103 before they enter the mixer M by another part of the temperature control device T may also be provided. As a result, temperature control may be carried out particularly precisely and homogeneously by the control device S via the distributed temperature control device T.

The feed gas 104, which has pressure, temperature, composition and flow rate parameters adjusted to the specified values, is supplied to the reformer R. This is where the actual processing of the feed gas takes place. For this purpose, the reformer R is supplied with a catalyst, which must first be activated before it is used to process the feed gas 104 to produce a raw product gas 105.

In order to activate the catalyst, in the example presented in the reformer R, reducing conditions must be set in the reformer R, as explained at the outset.

### EXAMPLES

The activation conditions provided according to the invention were tested in a series of examples and compared with counterexamples not according to the invention. For the sake of clarity, examples and counterexamples are numbered in a sequence. The following tables summarize the activation conditions used in these examples and counterexamples, wherein Table 1 indicates the composition of the activation gas and Table 2 indicates the physical activation conditions.

TABLE 1

| | Hydrogen | Water | Nitrogen + |
|---|---|---|---|
| Example no. | [%] | [%] | Argon [%] |
| Example 1 | 50 | 20 | 30 + 0 |
| Example 2 | 50 | 20 | 30 + 0 |
| Example 3 | 50 | 20 | 30 + 0 |
| Counterexample 4 | 50 | 20 | 30 + 0 |
| Counterexample 5 | 47.5 | 47.5 | 0 + 5 |
| Example 6 | 47.5 | 0 | 47.5 + 5 |
| Example 7 | 50 | 10 | 35 + 5 |
| Example 8 | 50 | 30 | 0 + 20 |
| Counterexample 9 | 47.5 | 47.5 | 0 + 5 |
| Example 10 | 55 | 20 | 25 + 5 |
| Counterexample 11 | 50 | 0 | 50 + 0 |
| Example 12 | 50 | 30 | 20 + 0 |

TABLE 2

| | Temperature | Pressure | GHSV | Time |
|---|---|---|---|---|
| Example no. | [° C] | [bar (abs.)] | [h⁻¹] | [h] |
| Example 1 | 750 | 6 | 800 | 16 |
| Example 2 | 800 | 6 | 2800 | 18 |
| Example 3 | 750 | 6 | 2800 | 18 |
| Counterexample 4 | 700 | 6 | 2800 | 18 |
| Counterexample 5 | 850 | 20 | 1200 | 12-14 |
| Example 6 | 700-850* | 5 | 1200 | 3 |
| Example 7 | 700-850* | 5 | 1200 | 6 |
| Example 8 | 700-850* | 5 | 1200 | 6 |
| Counterexample 9 | 700-850* | 5 | 1200 | 3 |
| Example 10 | ≥800° C. | 6 | 800 | 12 |
| Counterexample 11 | 750 | 6 | 364 | 16 |
| Example 12 | 750 | 6 | 800 | 16 |

*changed in increments of 50K.

The examples and counterexamples summarized in Tables 1 and 2 with regard to the activation conditions are discussed in detail below.

### Example 1

A laboratory plant having a catalyst volume of 823 milliliters was used. The specified temperatures relate to the catalyst bed temperature at the reactor outlet.

Specific example values for regular operation are, for example: 0.7% hydrogen, 27.3% methane, 27.3% water, 44.7% carbon dioxide, temperature 950° C., pressure 30 bara, GHSV 1520 h⁻¹. A relative methane conversion of 98% based on the equilibrium conversion could be achieved.

In comparison with the examples below, Example 1 shows that the values determined on the basis of the laboratory plant may be transferred to other plants and the specific design of the plant therefore plays no or a lesser role compared to the activation conditions used.

### Examples 2 to 4

Specific example values for testing the activation content were in each case carried out in a pilot plant (so-called mini plant) with a catalyst volume of 200 milliliters in the form of tablets (analogous to PCT/EP2020/052296). The tests were carried out using isothermal operation over the entire catalyst bed, wherein the specified temperatures reflect the catalyst bed temperatures, which were measured at different vertical positions using a multi-thermocouple within the catalyst bed. The temperatures were adjusted by means of four individual heating zones along the reactor tube filled with catalyst.

Specific example values for regular operation are, for example: 0.5% hydrogen, 25.9% methane, 25.9% water, 42.5% carbon dioxide, 5.3% nitrogen, temperature 950° C., pressure 22 bara, GHSV 3850 h⁻¹.

In Example 2, absolute conversions of methane and carbon dioxide of 91.4% and 70.6% respectively were observed during regular operation.

In Example 3, absolute conversions of methane and carbon dioxide of 90.4% and 69.1% respectively were observed during regular operation.

In Example 4, absolute conversions of methane and carbon dioxide of 76.0% and 61.8% respectively were observed during regular operation.

Examples 2 to 4, in conjunction with Example 1, show in particular that comparable reactions may be achieved even at an activation temperature of 750° C. instead of 800° C., but that a poorer reaction can be observed at only 700° C. In other words, Examples 2 to 4 show that an increase in the activation temperature from 700° C. to at least 750° C. leads to a significant increase in the activity of the catalyst in regular operation. From an energy perspective, 750° C. instead of 800° C. is considered advantageous.

### Counterexample 5

Specific example values for an activation phase were tested in a laboratory plant having a catalyst volume of 15 milliliters, with isothermal operation. The specified temperature relates to the temperature of the furnace.

Specific example values for regular operation may be as follows, for example: 25.5% methane, 3% hydrogen, 41% carbon dioxide, 25.5% water, 5% argon, temperature 850° C., pressure 20 bara, GHSV between 1200 h⁻¹ and 4000 h⁻¹.

It was found that partial activation of the catalyst can be achieved. However, under high GHSV (4000 h⁻¹) and under these regular operating conditions, deactivation of the catalyst in situ is observed. Therefore, this example shows that the quantity of water used during activation in this counterexample was too high.

### Example 6

Specific example values for an activation phase were tested in a laboratory plant having a catalyst volume of 15 milliliters, with isothermal operation. The specified temperature relates to the temperature of the furnace.

Specific example values for regular operation may be as follows, for example: 20% methane, 47.5% hydrogen, 20% water, 0% nitrogen, 12.5% argon, temperature 700° C., 750° C., 800° C., 850° C. (in each case the same temperature as the activation temperature), GHSV 1200 h⁻¹, pressure 5 bara.

A stable methane conversion for regular operation could be achieved at temperatures of 750° C. or higher. A relative methane conversion of more than 80% occurs at 750° C. (11.7 mol-% residual methane content) and 96% occurs at 850° C. (<5.2 mol-% residual methane content). However, this is less satisfactory compared to higher water contents in the activation gas.

### Example 7

Specific example values for an activation phase were tested in a laboratory plant having a catalyst volume of 15 milliliters, with isothermal operation. The specified temperature relates to the temperature of the furnace.

Specific example values for regular operation may be as follows, for example: 20% methane, 5% hydrogen, 20% water, 50% nitrogen, 5% argon, temperature 700° C., 750° C., 800° C., 850° C. (in each case the same temperature as the activation temperature), GHSV 1200 h⁻¹, pressure 5 bara.

A stable methane conversion for regular operation is only achieved at temperatures of 800° C. or higher: relative methane conversion >97% at 800° C. (6.5 mol-% residual methane content) and 99% at 850° C. (<3.8 mol-% residual methane content).

Due to the higher addition of water in the activation gas of 10%, the methane conversions can thus be significantly increased compared to Example 6 and reach satisfactory values, but slightly higher temperatures are still required than with a water content of 20% (see above).

### Example 8

Specific example values for an activation phase were tested in a laboratory plant having a catalyst volume of 15 milliliters, with isothermal operation. The specified temperature relates to the temperature of the furnace.

Specific example values for regular operation may be as follows, for example: 20% methane, 5% hydrogen, 20% water, 50% nitrogen, 5% argon, temperature 700° C., 750° C., 800° C., 850° C. (in each case the same temperature as the activation temperature), GHSV 1200 h⁻¹, pressure 5 bara.

A stable methane conversion for regular operation is only achieved at temperatures of 800° C. or higher: relative methane conversion >87% at 800° C. (6.5 mol-% residual methane content) and 99% at 850° C. (<3.6 mol-% residual methane content).

Example 8 therefore shows that use of a water content of 30% is still possible during activation and that this yields satisfactory methane conversions, but that a temperature of 800° C. should be used.

### Counterexample 9

Specific example values for an activation phase were tested in a laboratory plant having a catalyst volume of 15 milliliters, with isothermal operation. The specified temperature relates to the temperature of the furnace.

Specific example values for regular operation may be as follows, for example: 4.75% methane, 47.5% hydrogen, 42.75% water, 0% nitrogen, 5% argon, temperature 700° C., 750° C., 800° C., 850° C. (in each case the same temperature as the activation temperature), GHSV 1200 h⁻¹, pressure 5 bara.

A stable methane conversion for regular operation is only achieved at temperatures of 900° C. or higher: relative methane conversion >89% at 900° C. (0.05 mol-% residual methane content; for comparison: relative methane conversion >52% at 850° C. (<2.4 mol-% residual methane content).

Example 9 shows that the water content of 47.5% during activation is too high and only yields satisfactory conversions at very high temperatures.

### Example 10

Specific example values for an activation phase were tested in a laboratory plant having a catalyst volume of 15 milliliters, with isothermal operation. The specified temperature relates to the temperature of the furnace.

Specific example values for regular operation may be as follows, for example: 25.9% methane, 0% hydrogen, 25.9% water, 42.5% carbon dioxide, 0% nitrogen, 5% argon, temperature 700° C., 750° C., 800° C., 850° C. (in each case the same temperature as the activation temperature), GHSV 1200 h⁻¹, pressure 5 bara.

A stable methane conversion for regular operation is achieved for over 300 hours of time-on-stream (TOS). Relative methane conversion 98% (1.0 mol-% residual methane content).

### Counterexample 11

Specific example values for an activation phase were tested in a laboratory plant having a catalyst volume of 823 milliliters. The specified temperatures relate to the catalyst bed temperature at the reactor outlet.

Specific example values for regular operation may be as follows, for example: 0.7% hydrogen, 27.3% methane, 27.3% water, 44.7% carbon dioxide, temperature 950° C., pressure 30 bara, GHSV 1520 h⁻¹. A relative methane conversion of 80% based on the equilibrium conversion was achieved.

Counterexample 11 shows again that an anhydrous activation gas causes unsatisfactory activation.

### Example 12

Specific example values for an activation phase were tested in a laboratory plant having a catalyst volume of 823 ml. The specified temperature relates to the catalyst bed temperature at the reactor outlet.

Specific example values for regular operation may be as follows, for example: 0.7% hydrogen, 27.3% methane, 27.3% water, 44.7% carbon dioxide, temperature 950° C., pressure 30 bara, GHSV 1520 h⁻¹.

This results in a relative methane conversion of 99% based on the equilibrium conversion. Although this is in the same order of magnitude as with a functioning activation with 20% water, a deviating temperature profile is formed. When activated with 30% water, the temperature profile in the catalyst bed and on the outer wall of the reactor shifts to higher temperatures. This indicates a reaction zone that has been shifted to the rear part of the reactor. From a process engineering perspective, this is undesirable for use in a commercial plant.

Observed together, the above examples demonstrate the value ranges recognized as particularly advantageous according to the invention.

1. A method for activating a catalyst for catalytic reforming, and according to which an activation gas that contains steam and hydrogen is passed over the catalyst to be activated at an activation temperature during an activation period, wherein the activation gas comprises 10 to 30 mol-% steam, 40 to 60 mol-% hydrogen and 20 to 40 mol-% one or more inert gases, and the activation temperature is at least 750° C.

2. The method according to claim 1, according to which the catalytic reforming is carried out with carbon dioxide being reacted.

3. The method according to claim 1, according to which the activation gas is passed over the catalyst to be activated at an hourly space velocity of 200 to 4000 h⁻¹ and/or according to which the activation period is more than 4 hours.

4. The method according to claim 1, according to which the catalyst is a hexaaluminate-containing catalyst comprising a hexaaluminate-containing phase which contains cobalt and at least one further element from the group of lanthanum, barium and strontium.

5. The method according to claim 2, according to which the activation gas is passed over the catalyst to be activated at an hourly space velocity of 200 to 4000 h⁻¹ and/or according to which the activation period is more than 4 hours.

6. The method according to claim 2, according to which the catalyst is a hexaaluminate-containing catalyst comprising a hexaaluminate-containing phase which contains cobalt and at least one further element from the group of lanthanum, barium and strontium.

7. The method according to claim 3, according to which the catalyst is a hexaaluminate-containing catalyst comprising a hexaaluminate-containing phase which contains cobalt and at least one further element from the group of lanthanum, barium and strontium.

8. The method according to claim 5, according to which the catalyst is a hexaaluminate-containing catalyst comprising a hexaaluminate-containing phase which contains cobalt and at least one further element from the group of lanthanum, barium and strontium.
